(19) United States
(12) Patent Application Publication
(10) Pub. No.: US 2014/0321751 A1
(43) Pub. Date: Oct. 30, 2014

(54) CHARACTER INPUT APPARATUS AND METHOD

(71) Applicant: Kabushiki Kaisha Toshiba, Tokyo (JP)

(72) Inventor: Masayuki Okamoto, Kawasaki-shi (JP)

(73) Assignee: KABUSHIKI KAISHA TOSHIBA, Tokyo (JP)

(21) Appl. No.: 14/196,266

(22) Filed: Mar. 4, 2014

(30) Foreign Application Priority Data
Apr. 26, 2013 (JP) 2013-094361

(51) Int. Cl. G06K 9/00

(52) U.S. Cl. CPC G06K 9/00402
USPC 382/189

(57) ABSTRACT

According to an embodiment, a character input apparatus includes a handwriting input unit, an input target determination unit, a character recognition unit, and a character input unit. The handwriting input unit is configured to receive an input of handwriting onto a display screen on which an image including one or more input forms is displayed. The input target determination unit is configured to determine an input form of the one or more input forms as a target of the handwriting. The character recognition unit is configured to apply character recognition to the handwriting to obtain a character corresponding to the handwriting. The character input unit is configured to input the character to the input form.

### CROSS-REFERENCE TO RELATED APPLICATIONS

This application is based upon and claims the benefit of priority from Japanese Patent Application No. 2013-094361, filed Apr. 26, 2013, the entire contents of which are incorporated herein by reference.

### FIELD

Embodiments described herein relate generally to a character input apparatus and method.

### BACKGROUND

A terminal apparatus (for example, a tablet terminal, smartphone, and the like) including a handwriting input interface which allows a user to make handwriting inputs by a pen or finger has prevailed. In such terminal apparatus, for example, when the user wants to input a character in a text box in a browsed Web page, he or she selects the text box, and then inputs a character by handwriting. Then, the character recognition result of the input character is reflected to the text box. In this manner, in order to input a character in a text box, the user is required to perform a two-step operation; that is, text box selection and character input.

Also, in a handwriting input search for a smartphone/tablet of Google™, the user is required to perform a two-step operation; that is, handwriting mode selection and character input. Furthermore, a character input technique adopted for this handwriting input search can be utilized when only one text box is displayed on a search screen.

It is required to allow the user to input a character to an input form such as a text box by a simpler operation.

### BRIEF DESCRIPTION OF THE DRAWINGS

FIG. 1 is a block diagram of a character input apparatus according to the first embodiment;

FIG. 2 is a flowchart showing an example of the processing sequence of the character input apparatus shown in FIG. 1;

FIG. 3A is a view showing an example of a screen on a Web browser;

FIG. 3B is a view showing a state in which handwriting is input on the screen shown in FIG. 3A;

FIG. 3C is a view showing a state in which a character recognition result corresponding to the handwriting shown in FIG. 3B is input to the text box on the screen shown in FIG. 3A;

FIG. 4A is a view showing an example of a screen on a Web browser;

FIG. 4B is a view showing an example of an HTML document corresponding to the screen shown in FIG. 4A;

FIG. 5 is a view showing how HTML layers shown in FIG. 4B are reflected to the screen shown in FIG. 4A;

FIGS. 6A and 6B are views showing a mapping example from coordinates on a display screen to an HTML document;

FIG. 7A is a view showing a state in which handwriting is input by handwriting in a text box “departure station”;

FIG. 7B is a table showing a mapping result of the handwriting shown in FIG. 7A;

FIG. 8A is a view showing an assignment example of coordinates to a screen on a Web browser;

FIG. 8B is a table showing the correspondence relationship between types of objects and their display regions on the screen;

FIG. 9 is a view showing an example of an operation for an already input text box;

FIG. 10 is a view showing another example of an operation for an already input text box;

FIGS. 11A and 11B are views showing an operation example for a select box;

FIG. 12 is a schematic block diagram showing a character input apparatus according to the second embodiment;

FIG. 13 is a flowchart showing an example of the processing sequence of the character input apparatus shown in FIG. 12; and

FIG. 14 is a view showing an example in which an input determination unit shown in FIG. 12 determines that handwriting does not target any input element.

### DETAILED DESCRIPTION

According to an embodiment, a character input apparatus includes a handwriting input unit, an input target determination unit, a character recognition unit, and a character input unit. The handwriting input unit is configured to receive an input of handwriting onto a display screen on which an image including one or more input forms is displayed. The input target determination unit is configured to determine an input form of the one or more input forms as a target of the handwriting. The character recognition unit is configured to apply character recognition to the handwriting to obtain a character corresponding to the handwriting. The character input unit is configured to input the character to the input form.

Various embodiments will be described hereinafter with reference to the accompanying drawings. In the embodiments, like reference numbers denote like elements, and a repetitive description thereof will be avoided.

### First Embodiment

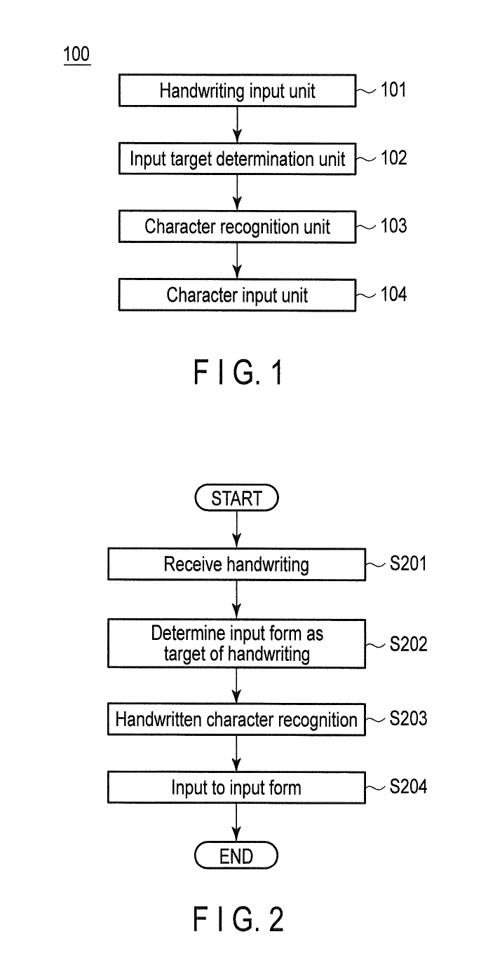

FIG. 1 schematically shows a character input apparatus 100 according to the first embodiment. As shown in FIG. 1, the character input apparatus 100 includes a handwriting input unit 101, input target determination unit 102, character recognition unit 103, and character input unit 104. For example, the character input apparatus 100 is applicable to a terminal apparatus including a display unit, which displays an image corresponding to a structured document including a plurality of elements on a display screen of a display device, and a handwriting input interface which allows the user to input handwriting by handwriting using a pointing member (for example, a pen, finger, or the like). As the terminal apparatus, for example, a personal computer (PC), smartphone, tablet terminal, and the like can be used. The structured document includes, for example, a document described using HTML (HyperText Markup Language), that described using XML (eXtensible Markup Language), EPUB (Electronic PUBlication) document, and the like.

The following description of this embodiment will be given under the assumption that the structured document is an HTML document, and the display unit is a Web browser, which displays an image (Web page in this case) corresponding to an HTML document acquired from an external server or the like. The HTML document includes a plurality of HTML elements described using tags. Each HTML element is formed by start and end tags, and a character string (text data) arranged between these tags. Furthermore, assume that the HTML document includes one or more input elements. The input elements are displayed on a screen of the Web browser as input forms such as text boxes and select boxes. The select box is also called a drop-down list or pull-down menu. The character input apparatus 100 of this embodiment allows the user to easily input characters in the input forms displayed on the display screen by handwriting.

The handwriting input unit 101 receives an input of handwriting from the user. More specifically, the handwriting input unit 101 includes the aforementioned handwriting input interface, and the user can input desired handwriting (for example, a character, character string, and the like) at a desired position on the Web page displayed on the screen using the handwriting input interface.

The input target determination unit 102 determines an input form of one or more input forms displayed on the display screen as a target of the input handwriting. The character recognition unit 103 applies character recognition to the input handwriting, and obtains a character corresponding to the handwriting as a character recognition result. In this case, “character” is not limited to one character, and includes the meaning of a character string. The character input unit 104 inputs the character obtained by the character recognition unit 103 to the input form determined by the input target determination unit 102.

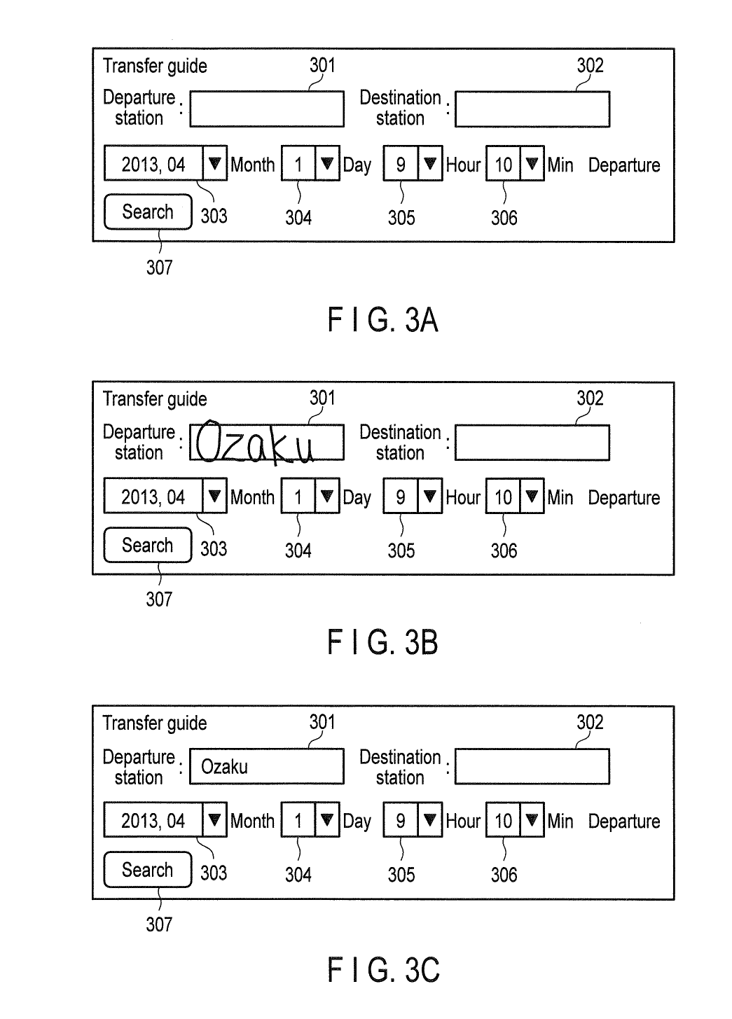

FIG. 2 schematically shows the processing sequence of the character input apparatus 100. Initially, a Web page including one or more input forms is displayed on the display screen. For example, a part of a Web page of a transfer guide service is displayed, as shown in FIG. 3A. FIG. 3A shows a screen (a display region of an image corresponding to the HTML document) on the Web browser, and does not show a menu bar, search bar, and the like. The transfer guide service presents an optimal route, fare, required time, and the like using public transport such as a train, bus, and airplane when the user designates “departure station”, “destination station”, “departure date and time”, and the like. The screen shown in FIG. 3A displays a plurality of input forms, for example, a text box 301 used to input “departure station”, a text box 302 used to input “destination station”, and select boxes 303, 304, 305, and 306 used to input “departure date and time”. Furthermore, the screen displays a search button 307 used to conduct a search.

In step S201 of FIG. 2, the handwriting input unit 101 receives an input of handwriting from the user. For example, as shown in FIG. 3B, the user inputs [Ozaku] by handwriting on the text box 301 using the handwriting input interface. In step S202 of FIG. 2, the input target determination unit 102 determines one of the displayed input forms as a target of the input handwriting. In the example shown in FIG. 3B, the input target determination unit 102 determines one of the text boxes 301 and 302 and the select boxes 303 to 306 as a target of the input handwriting. In this example, since the input handwriting partially overlaps the text box 301, the input target determination unit 102 determines the text box 301 as a target of the input handwriting. A method of determining an input form as a target of input handwriting will be described in detail later.

In step S203 of FIG. 2, the character recognition unit 103 applies character recognition to the handwriting input in step S201. In the example of FIG. 3B, a character string [Ozaku] is obtained as a character recognition result. In step S204 of FIG. 2, the character input unit 104 inputs the character recognition result of the character recognition unit 103 to the input form determined by the input target determination unit 102. For example, as shown in FIG. 3C, the character string [Ozaku] is input to the text box 301.

In this way, the character input apparatus 100 receives an input of handwriting from the user, determines an input form as a target of the input handwriting, and inputs a character recognition result of the handwriting to the determined input form. Thus, the user can input a character to the desired input form without performing an operation for selecting an input form and an operation for opening a software keyboard. That is, the user can input a character to the input form by an easy operation.

Note that in the processing sequence shown in FIG. 2, the character recognition processing (step S203) is executed after the input target determination processing (step S202). Alternatively, the character recognition processing may be executed before the input target determination processing, or the input target determination processing and character recognition processing may be parallelly executed.

Furthermore, the input form as a character input target is not limited to those in the Web page, but may include a search bar or the like of the Web browser.

Next, the method of determining an input element as a target of input handwriting will be described in detail below.

As the determination method, a first method of specifying the input form as a target of handwriting by mapping a coordinate point sequence of the input handwriting onto the HTML document, a second method of specifying the input form as a target of handwriting based on the positions of the handwriting on the display screen and those of input forms on the display screen, and the like can be used.

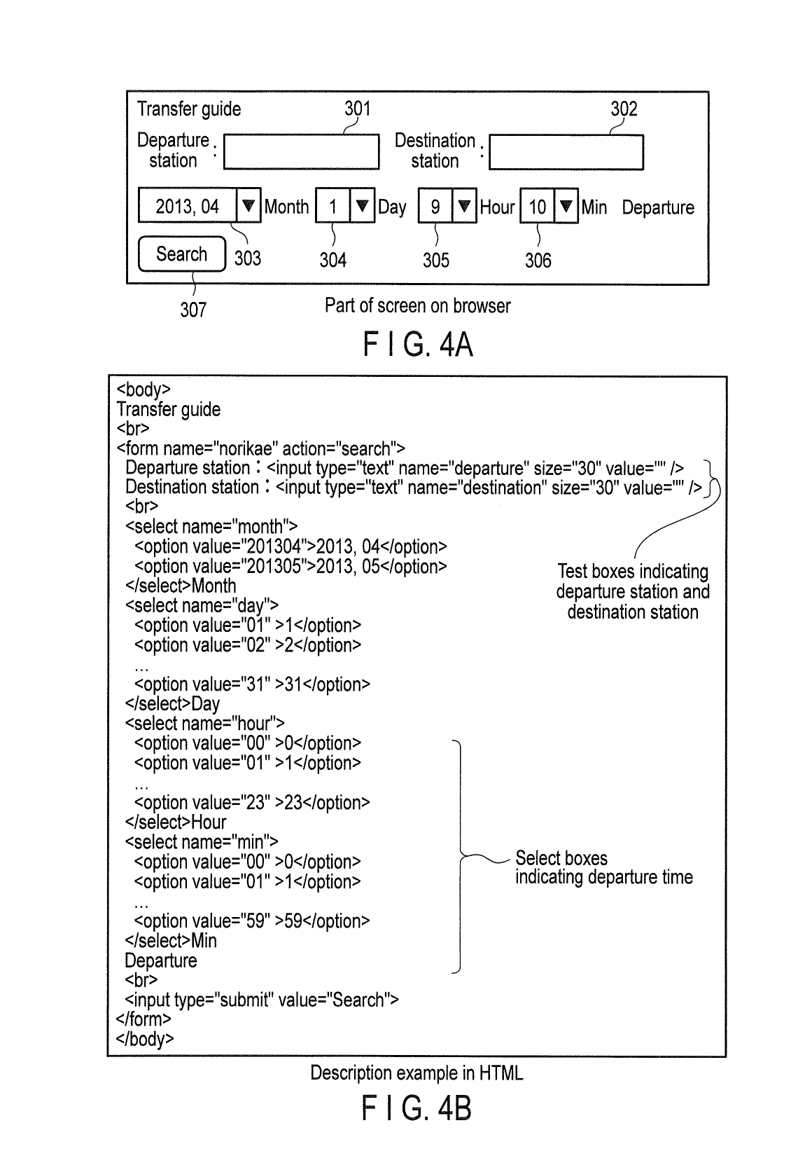

The first method will be described first with reference to FIGS. 4A, 4B, 5, 6A, 6B, 7A, and 7B.

FIG. 4A shows a screen on a Web browser, and FIG. 4B shows an example of an HTML document described to display an image (Web page) shown in FIG. 4A. FIG. 4A shows a Web page of a transfer guide service on the screen on the Web browser. Text boxes 301 and 302 shown in FIG. 4A correspond to <input> tags shown in FIG. 4B. Select boxes 303 to 306 shown in FIG. 4A correspond to <select> tags shown in FIG. 4B.

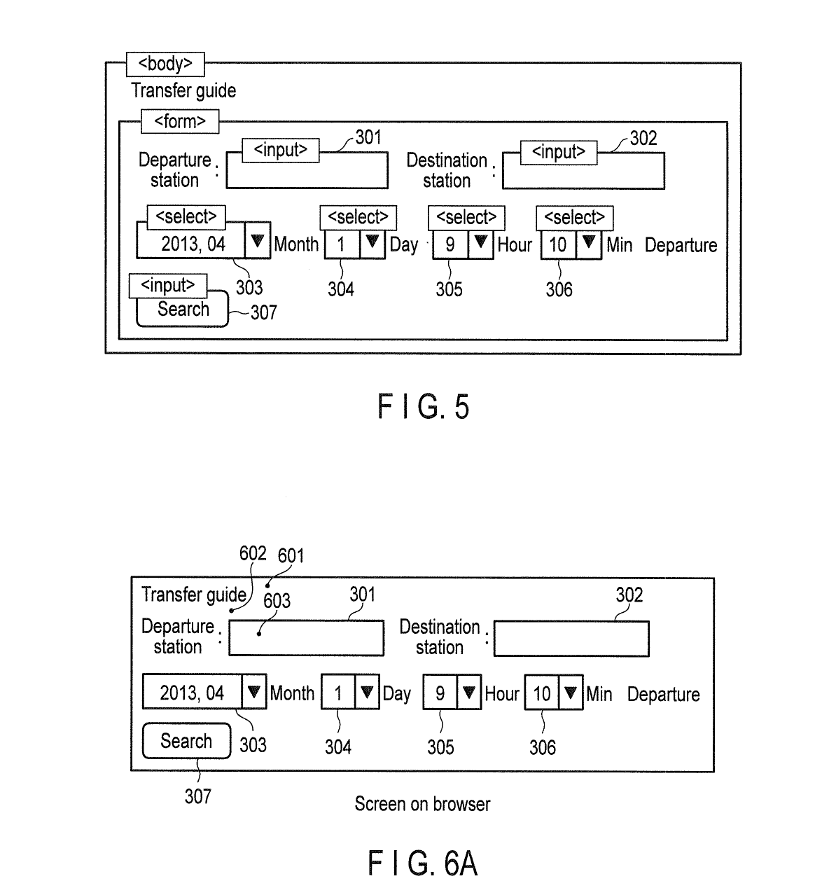

FIG. 5 shows how HTML layers shown in FIG. 4B are reflected to the screen shown in FIG. 4A. For example, the entire screen belongs to a layer bounded by <body> tags, the entire input range belongs to a layer bounded by <form> tags, and the text box 301 used to input “departure station” belongs to a layer of <input> tags. Therefore, when the user points to a certain point on the screen, a layer (element) corresponding to that point is determined. In this embodiment, the handwriting input unit 101 acquires input handwriting as a coordinate point sequence on the display screen. The handwriting input interface includes, for example, a touch panel arranged on the display screen of the display device, and coordinates of the touch panel respectively correspond to those of the display screen. Data of the coordinate point sequence is input to the input target determination unit 102.

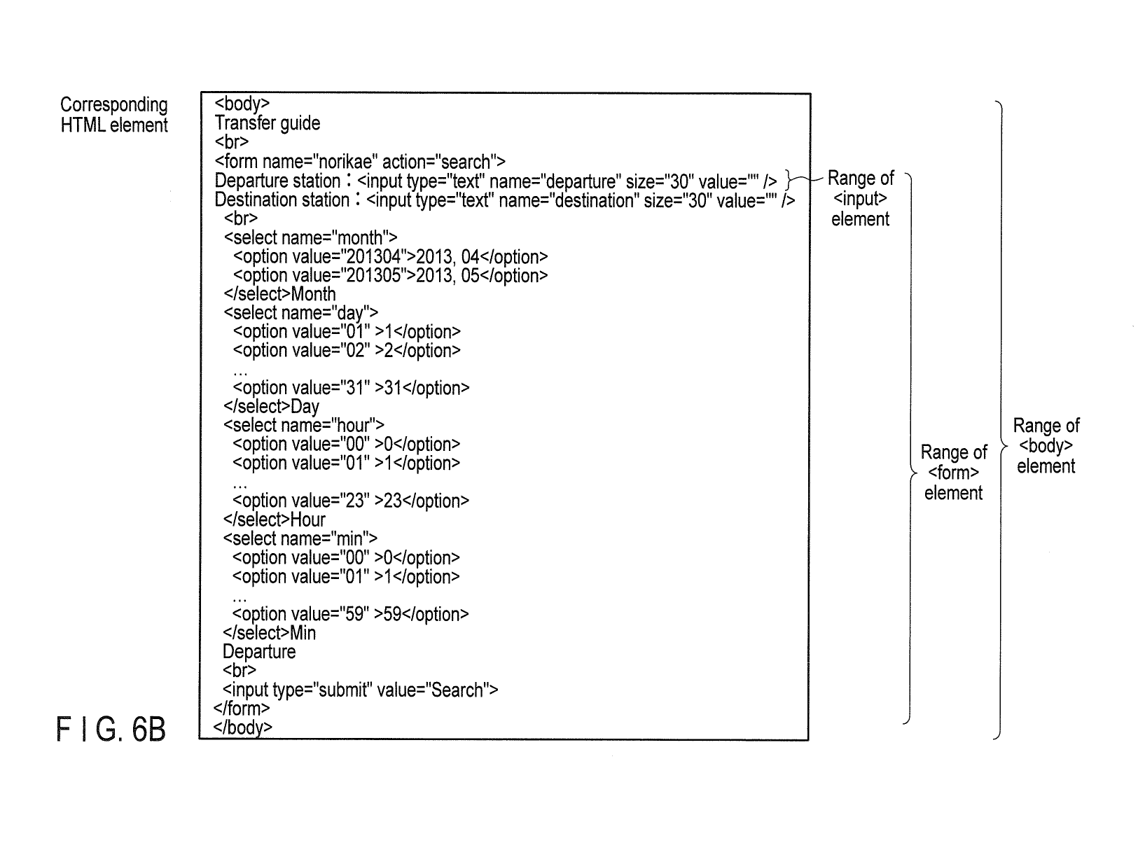

FIGS. 6A and 6B show a mapping example from coordinates on the display screen onto the HTML document. Referring to FIG. 5, a point 601 shown in FIG. 6A is included in a region which belongs to a <body> element shown in FIG. 6B. That is, when the coordinates of the point 601 are mapped on the HTML document, it is determined that the point 601 corresponds to the <body> element shown in FIG. 6B. Since a point 602 shown in FIG. 6A is included in a region which belongs to a <form> element, it is determined as a result of mapping that the point 602 corresponds to the <form> element shown in FIG. 6B. Since a point 603 shown in FIG. 6A is included in a region which belongs to an <input> element of “departure station”, it is determined as a result of mapping that the point 603 corresponds to the <input> element of “departure station” shown in FIG. 6B.

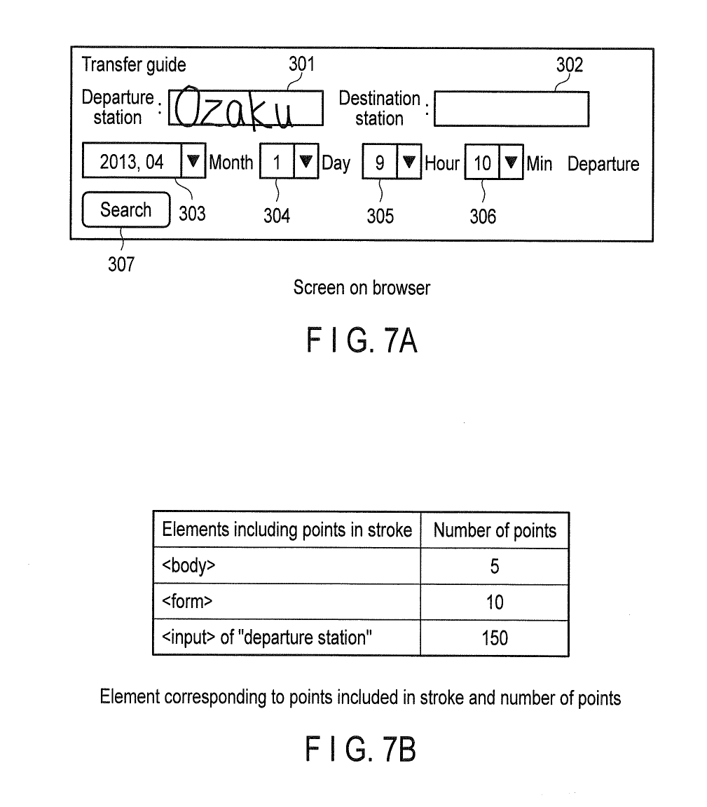

FIG. 7A shows a state in which handwriting [Ozaku] is input by handwriting in the text box 301 of “departure station”. As shown in FIG. 7A, since the handwriting protrudes from the text box 301, some coordinate points of the coordinate point sequence which forms the handwriting are often mapped on elements other than the text box 301. FIG. 7B is a table showing elements corresponding to the coordinate point sequence of the handwriting shown in FIG. 7A and the numbers of coordinate points mapped on these elements. In this example, a mapping result indicating that five coordinate points are mapped on the <body> element, 10 coordinate points are mapped on the <form> element, and 150 coordinate points are mapped on the <input> element used to input “departure station” is obtained. According to majority decision, it is determined that the input handwriting is input to the <input> element of “departure station”. Thus, the input target determination unit 102 determines the text box 301 used to input “departure station” as a target of the input handwriting [Ozaku].

Alternatively, the input target determination unit 102 may execute input target determination according to a method of calculating coordinates of a centroid of the coordinate point sequence which forms the handwriting, and checking which element the calculated coordinates correspond to, a method of checking a corresponding element according to a place where the first several strokes of the handwriting are input while attaching importance to a write starting position, or the like.

In the aforementioned first method, when the handwriting is input to overlap the input form, the input element corresponding to the input handwriting can be detected. However, when the handwriting is written outside the input form, it is often difficult to find an input element corresponding to the handwriting. The second method to be described below can cope with a case in which the handwriting is written outside the input form.

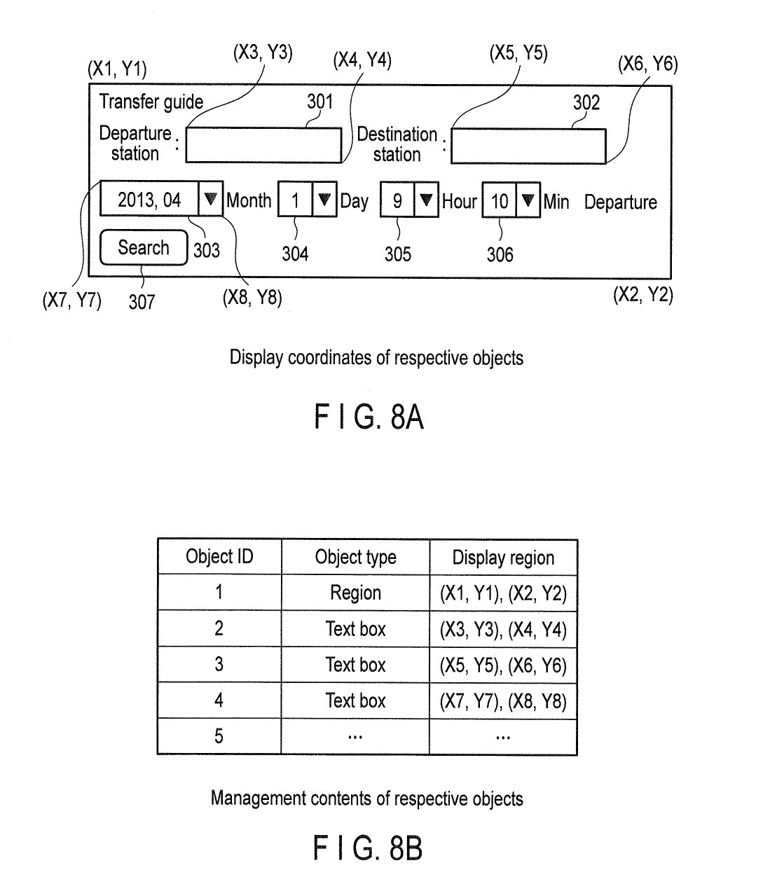

The second method will be described below with reference to FIG. 7A and FIGS. 8A and 8B. As described above, the second method specifies an input form as a target of handwriting based on the positions of the input handwriting on the display screen and those of input forms on the display screen. More specifically, the second method manages coordinates, on the display screen, of text boxes, images, and the like displayed on the Web browser, and calculates distances between the coordinates where handwriting is input on the display screen and those of respective elements on the display screen, thereby specifying an input form located closest to the handwriting. Thus, even when the handwriting is written outside the input form, it can be recognized that the handwriting is input to the input form in the vicinity of the handwriting.

FIGS. 8A and 8B show a management example of coordinates of objects on the display screen when HTML elements are rendered as objects. FIG. 8A shows an example in which Euclidean coordinates indicating rectangular regions are assigned to the display screen. For example, a rectangular region bounded by (Xl, Yl) and (X2, Y2) is set for the entire display screen, and the text box 301 used to input “departure station” is rendered on a rectangular region bounded by (X3, Y3) and (X4, Y4). Furthermore, the text box 302 is rendered on a rectangular region bounded by (X5, Y5) and (X6, Y6), and the select box 303 is rendered on a rectangular region bounded by (X7, X7) and (X8, X8). FIG. 8B is a table showing the correspondence relationship between the types of objects rendered by the HTML elements and their display regions. When the correspondence relationship between the objects and display regions is known in advance in this way, and when the handwriting is input by handwriting as shown in FIG. 7A, an input form which includes a largest number of points of the coordinate point sequence, that which includes a centroid of all or some coordinates of the coordinate point sequence, or that corresponding to a shortest distance (for example, a distance from a centroid of a text box or a distance form a boundary line of a text box) can be determined. In this manner, the correspondence relationship between the input handwriting and any of the input forms can be taken.

An operation example for an already-input text box (i.e., text box to which a character has already been input) is will be described below.

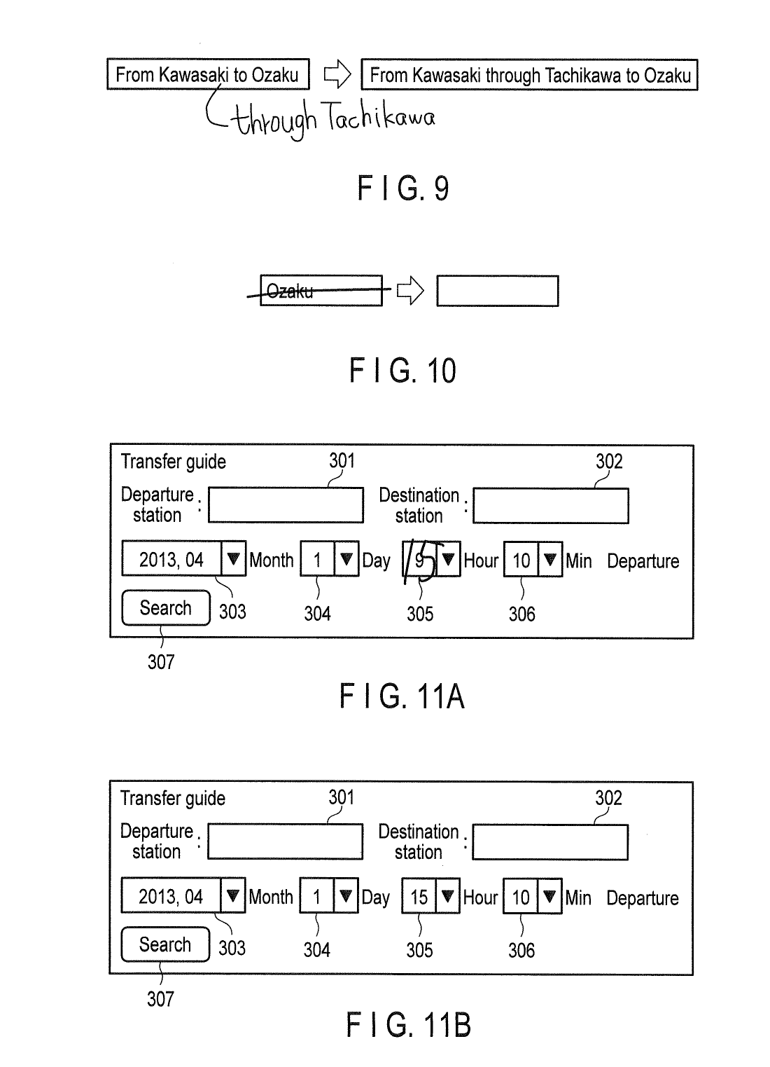

FIG. 9 shows an example of additional input to an already input text box. In FIG. 9, a character string [From Kawasaki to Ozaku] has already been input to the text box. As shown in FIG. 9, when a character string [through Tachikawa] is input by drawing a leading line with respect to the already input text box, the character string [through Tachikawa] is inserted at a position of the character string designated by the leading line, that is, at a position between a character string [From Kawasaki] and character string [to Ozaku]. The leading line in this case includes a stroke such as an arrow which is used to designate an insertion position.

FIG. 10 shows an operation of an erase operation with respect to an already input text box. In FIG. 10, a character string [Ozaku] has already been input to the text box. As shown in FIG. 10, when a predetermined stroke (a horizontal line on the entire text box in this example) is drawn on the text box, contents of this text box are erased. The handwriting required to execute such predetermined operation is called a handwriting gesture.

As another operation example, when handwriting is input on the already input text box, contents already written in the text box are overwritten. More specifically, a character input to the text box is erased, and a character corresponding to newly input handwriting is input to that text box.

As still another operation example, when handwriting is input on the already input text box, a character corresponding to the input handwriting is additionally written in the text box. More specifically, the character corresponding to the input handwriting is added after an already input character.

Overwriting or additional writing to be executed when handwriting is input on the already input text box can be judged according to the position of the handwriting. For example, when handwriting is input to overlap a character in the text box, it is judged that overwriting is to be executed. When handwriting is input in the neighborhood of (for example, on the right side of) an already input character on the text box, it is judged that additional writing is executed. Alternatively, the user may switch an overwriting mode and additional writing mode on a setting screen of the character input apparatus 100.

An operation example for a select box will be described below with reference to FIGS. 11A and 11B. As shown in FIG. 11A, when the user inputs handwriting [15] to overlap the select box 305 used to designate “hour”, contents of the select box 305 are changed to characters [15] corresponding to the handwriting from [9] as shown in FIG. 11B. This operation is easier than conventional user operations for selecting the select box 305 to display choices (1, 2, . . . , 24), and selecting a desired hour from them.

As described above, the character input apparatus according to the first embodiment receives inputs of handwriting from the user, determines an input form in the display screen as a target of the input handwriting, and inputs a character recognition result of the input handwriting to the determined input form. Thus, the user can input a character to the input form by a simpler operation without making an operation for selecting the input form and an operation for opening a software keyboard.

### Second Embodiment

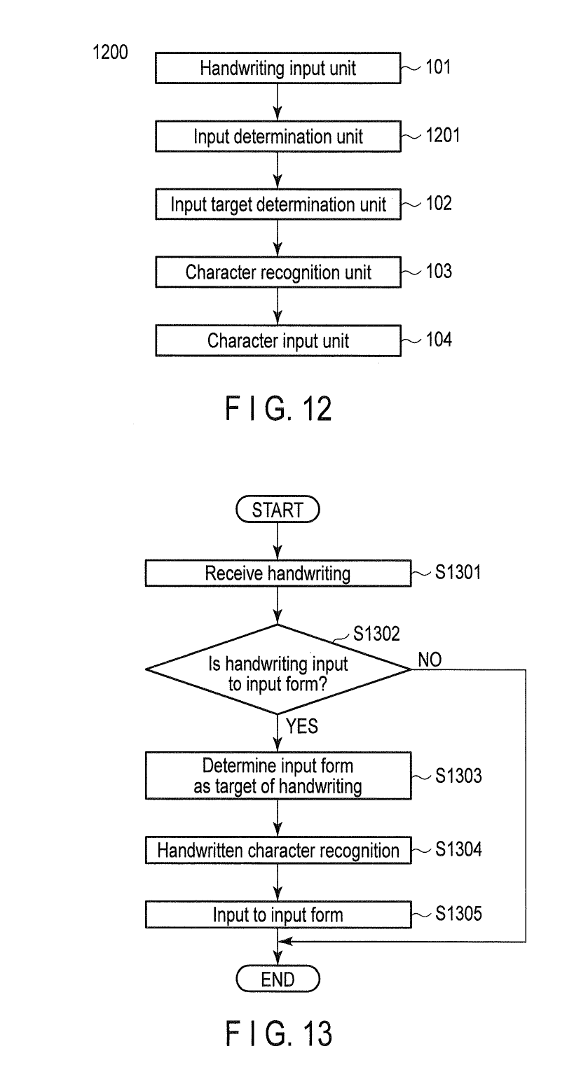

FIG. 12 schematically shows a character input apparatus 1200 according to the second embodiment. As shown in FIG. 12, the character input apparatus 1200 includes a handwriting input unit 101, input determination unit 1201, input target determination unit 102, character recognition unit 103, and character input unit 104. Since the handwriting input unit 101, input target determination unit 102, character recognition unit 103, and character input unit 104 have already been described in the first embodiment, a description of these units will not be repeated.

The input determination unit 1201 determines whether or not a target of input handwriting is an input form. More specifically, when the user inputs handwriting to at least partially overlap a text box, the input determination unit 1201 determines that an input target of the handwriting is an input form. However, when handwriting does not overlap any text box, the input determination unit 1201 judges that an input target of the handwriting is not an input form.

FIG. 13 schematically shows the processing sequence of the character input apparatus 1200. In step S1301 of FIG. 13, the handwriting input unit 101 receives an input of handwriting from the user. Since the processing of step S1301 is the same as that of step S201 shown in FIG. 2, a detailed description thereof will not be repeated.

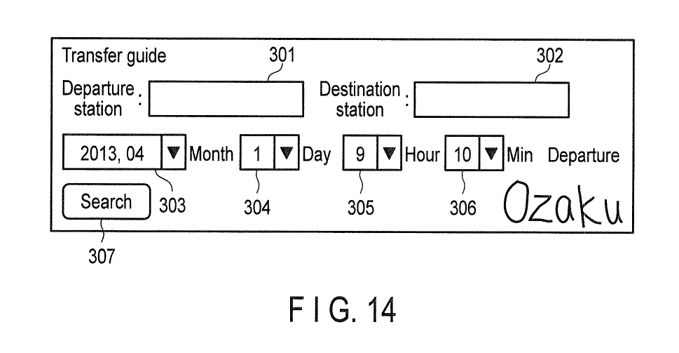

The input determination unit 1201 determines in step S1302 whether or not a target of the input handwriting is an input form. For example, when handwriting [Ozaku] does not overlap any of text boxes 301 and 302 and select boxes 303 to 306, as shown in FIG. 14, input determination unit 1201 judges that the target of the handwriting is not any input form. In this case, the input handwriting may be handled as a memo on the screen or may be erased as an error. A processing method of handwriting written outside input forms may be decided according to a position of the handwriting. For example, as settings of a Web browser, when handwriting is written outside input forms and on an upper portion of the display screen, a Web search may be conducted using a character recognition result of the handwriting; when handwriting is written outside input forms and on a lower portion of the display screen, an intra-page search may be conducted using a character recognition result of the handwriting.

If the input determination unit 1201 judges that the target of the input handwriting is an input form, the process advances to step S1303; otherwise, the processing ends. Since the processes of steps S1303, S1304, S1305 are the same as those of steps S202, S203, and S204 shown in FIG. 2, a description of these processes will not be repeated.

As described above, the character input apparatus according to the second embodiment can obtain the same effects as in the first embodiment. Furthermore, the character input apparatus according to the second embodiment determines whether or not handwriting is written outside an input form. Then, another process (for example, a Web search) can also be executed based on the handwriting written outside the input form.

Note that a terminal apparatus, which can discriminate a pen operation and an operation using a finger from each other, may judge the pen operation as an input of handwriting, and the operation using the finger as another operation (for example, scrolling).

Instructions in the processing sequences described in the aforementioned embodiment can be executed based on a program as software. A general-purpose computer system stores this program in advance and loads the stored program, thus obtaining the same effects as those by the character input apparatus of the aforementioned embodiment.

The instructions described in the aforementioned embodiment are recorded, as a program which can be executed by a computer, in a magnetic disk (flexible disk, hard disk, etc.), optical disk (CD-ROM, CD-R, CD-RW, DVD-ROM, DVD±R, DVD±RW, etc.), semiconductor memory, or similar recording medium. A storage format of a recording medium is not particularly limited as long as the recording medium is readable by a computer or embedded system. The computer loads the program from this recording medium, and controls a CPU to execute instructions described in the program based on this program, thus implementing the same operation as the character input apparatus of the aforementioned embodiment. Of course, the computer may acquire or load the program via a network.

Also, an OS (Operating System), database management software, MW (middleware) for a network, or the like, which runs on a computer, may execute some of the processes required to implement this embodiment based on instructions of a program installed from the recording medium in a computer or embedded system.

Furthermore, the recording medium of this embodiment is not limited to a medium independent of a computer or embedded system, and includes a recording medium, which stores or temporarily stores a program downloaded via a LAN, Internet, or the like.

The number of recording media is not limited to one, and the recording medium of this embodiment includes the case in which the processing of this embodiment is executed from a plurality of media. That is, the medium configuration is not particularly limited.

Note that the computer or embedded system of this embodiment is used to execute respective processes of this embodiment based on the program stored in the recording medium, and may have an arbitrary arrangement such as a single apparatus (for example, a personal computer, microcomputer, etc.), or a system in which a plurality of apparatuses are connected via a network.

The computer of this embodiment is not limited to a personal computer, and includes an arithmetic processing device, microcomputer, or the like included in an information processing apparatus, and is a generic name of a device and apparatus, which can implement the functions of this embodiment based on the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A character input apparatus comprising:
a handwriting input unit configured to receive an input of handwriting onto a display screen on which an image including one or more input forms is displayed;
an input target determination unit configured to determine an input form of the one or more input forms as a target of the handwriting;
a character recognition unit configured to apply character recognition to the handwriting to obtain a character corresponding to the handwriting; and
a character input unit configured to input the character to the input form.

2. The apparatus according to claim 1, wherein the handwriting input unit acquires a coordinate point sequence on the display screen as the handwriting, and
the input target determination unit specifies the input form as the target of the handwriting by mapping the coordinate point sequence on a structured document corresponding to the image.

3. The apparatus according to claim 1, wherein the input target determination unit specifies the input form as the target of the handwriting based on a position of the handwriting on the display screen and positions of the one or more input forms on the display screen.

4. The apparatus according to claim 1, wherein when a user draws a leading line with respect to an input form including an already input character and then inputs handwriting, a character obtained as a result of the character recognition for the handwriting is input to a position of the input form including the already input character designated by the leading line.

5. The apparatus according to claim 1, wherein the one or more input forms include at least one of a text box and a select box.

6. The apparatus according to claim 1, wherein when a user inputs predetermined handwriting with respect to an input form including an already input character, the already input character are erased.

7. The apparatus according to claim 1, wherein the input target determination unit determines an input form on which the handwriting at least partially overlaps as the target of the handwriting.

8. The apparatus according to claim 1, wherein when a user inputs handwriting to an input form including an already input character, a character obtained as a result of the character recognition for the handwriting is overwritten or additionally written on the input form.

9. A character input method comprising:
receiving an input of handwriting onto a display screen on which an image including one or more input forms is displayed;
determining an input form of the one or more input forms as a target of the handwriting;
applying character recognition to the handwriting to obtain a character corresponding to the handwriting; and
inputting the character to the input form.

10. The method according to claim 9, wherein the receiving comprises acquiring a coordinate point sequence on the display screen as the handwriting, and
the determining comprises specifying the input form as the target of the handwriting by mapping the coordinate point sequence on a structured document corresponding to the image.

11. The method according to claim 9, wherein the determining comprises specifying the input form as the target of the handwriting based on a position of the handwriting on the display screen and positions of the one or more input forms on the display screen.

12. The method according to claim 9, wherein when a user draws a leading line with respect to an input form including an already input character and then inputs handwriting, a character obtained as a result of the character recognition for the handwriting is input to a position of the input form including the already input character designated by the leading line.

13. The method according to claim 9, wherein the one or more input forms include at least one of a text box and a select box.

14. The method according to claim 9, wherein when a user inputs predetermined handwriting with respect to an input form including an already input character, the already input character are erased.

15. The method according to claim 9, wherein the determining comprises determining an input form on which the handwriting at least partially overlaps as the target of the handwriting.

16. The method according to claim 9, wherein when a user inputs handwriting to an input form including an already input character, a character obtained as a result of the character recognition for the handwriting is overwritten or additionally written on the input form.

17. A non-transitory computer readable medium including computer executable instructions, wherein the instructions, when executed by a processor, cause the processor to perform a method comprising:
receiving an input of handwriting onto a display screen on which an image including one or more input forms is displayed;
determining an input form of the one or more input forms as a target of the handwriting;
applying character recognition to the handwriting to obtain a character corresponding to the handwriting; and
inputting the character to the input form.
